(19) United States
(12) Patent Application Publication
(10) Pub. No.: US 2026/0223005 A1
(43) Pub. Date: Jul. 30, 2026

(54) CSI ENHANCEMENTS FOR DYNAMIC DOWNLINK TRANSMIT POWER ADAPTATION USING MULTIPLE CSI REPORT CONFIGURATIONS

(71) Applicant: APPLE INC., Cupertino, CA (US)

(72) Inventors: Sigen Ye, San Diego, CA (US); Dawei Zhang, Saratoga, CA (US); Dan Wu, Beijing (CN); Wei Zeng, San Diego, CA (US); Haitong Sun, Cupertino, CA (US); Hong He, San Jose, CA (US)

(21) Appl. No.: 19/145,711

(22) PCT Filed: Feb. 16, 2023
(86) PCT No.: PCT/CN2023/076534

§ 371 Date: Jul. 3, 2025

(51) Int. Cl. H04W 52/18; H04W 24/10

(52) U.S. Cl. CPC H04W 52/18; H04W 24/10

(57) ABSTRACT

A wireless communication system may use multiple power control offsets for a CSI-Reference signal (RS) resource. A network node may provide a user equipment (UE) with a Channel State Information (CSI) report configuration information element. The CSI report configuration information element includes one or both of a list of power control offsets for a CSI-Reference signal (RS) resource and a list of transmit powers for the CSI-RS. The UE may provide a CSI report with CSI measurements corresponding to one or more of the power control offsets.

### TECHNICAL FIELD

This application relates generally to wireless communication systems, including enhancements to CSI measurement configuration and reporting to better support dynamic PDSCH power adaptation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a portion of a CSI-ReportConfig information element in accordance with some embodiments.

FIG. 2 illustrates a CSI resource set information element and a CSI-RS information element in accordance with some embodiment.

FIG. 3 illustrates a simplified signal flow diagram for CSI reporting in accordance with some embodiment.

FIG. 4 illustrates a CSI-RS information element that includes a powerControlOffsetList in accordance with some embodiments

FIG. 5 illustrates a first CSI-RS resource corresponding to a first bitmap and a second CSI-RS resource corresponding to a second bitmap in accordance with some embodiment.

FIG. 6 illustrates MAC CE fields that may be used to directly update the list of powerControlOffset values for the CSI-RS resource(s) in accordance with some embodiment.

FIG. 7 illustrates MAC CE fields where a first CSI-RS resource configuration is corresponds to a first bitmap and a second CSI-RS resource corresponds to a second bitmap in accordance with some embodiment.

FIG. 8 illustrates a flowchart of a method for a network node in accordance with some embodiment.

FIG. 9 illustrates a flowchart of a method for a UE in accordance with some embodiment.

FIG. 10 illustrates a flowchart of a method for a network node in accordance with some embodiment.

FIG. 11 illustrates a flowchart of a method for a UE in accordance with some embodiment.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One goal for wireless communications systems is to reduce energy consumption. It may be beneficial to optimize the energy used by a UE and a network node. Accordingly, techniques may be studied and identified on the network node (e.g., gNB) side and the UE side to improve network energy savings in terms of both base station (BS) transmission and reception. These techniques may include features to achieve more efficient operation dynamically and/or semi-statically and finer granularity adaptation of transmissions and/or receptions. These goals may be accomplished with one or more of network energy saving techniques in time, frequency, spatial, and power domains, with potential support/feedback from UE, and potential UE assistance information (e.g., RAN1, RAN2).

Some embodiments herein assist in network energy saving. For example, some embodiments provide Channel State Information (CSI) enhancements for dynamic downlink transmit power adaption. Some embodiments specify enhancements on CSI related procedures including measurement and report, and signaling to enable efficient adaptation of power offset values between Physical Downlink Shared Channel (PDSCH) and CSI-reference signal (RS) [RAN1, RAN2].

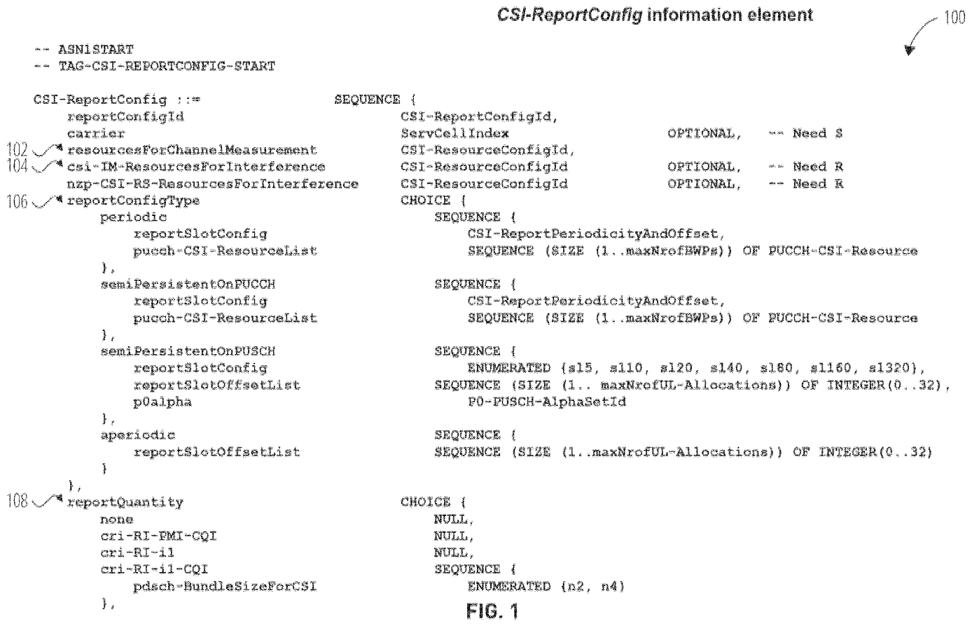

FIG. 1 illustrates a portion of a CSI-ReportConfig information element 100 in accordance with some embodiments. The networks downlink depends on feedback from a UE. Based on the feedback, the network makes a scheduling decision. The feedback from the UE includes a CSI report. A network node may send the CSI-ReportConfig information element 100 to a UE to configure the UE.

The CSI-ReportConfig information element 100 includes information for configuring a CSI report. For example, the illustrated CSI-ReportConfig information element 100 includes resources for channel measurements and for interference measurements (e.g., resourcesForChannelMeasurement field 102, csi-IM-ResourcesForInterference field 104). The CSI-ReportConfig information element 100 may also include type fields 106 that indicate the report type (e.g., periodic, semi-persistent, or aperiodic).

The CSI-ReportConfig information element 100 may also indicate what the UE is to report in a reportQuantity field 108. For example, the UE may be configured to report channel quality information (CQI), precoding matrix indicators (PMI), and rank indicator (RI). The network may use this information to configure future scheduling. Additional configuration elements that are not shown may be included in the CSI-ReportConfig information element 100.

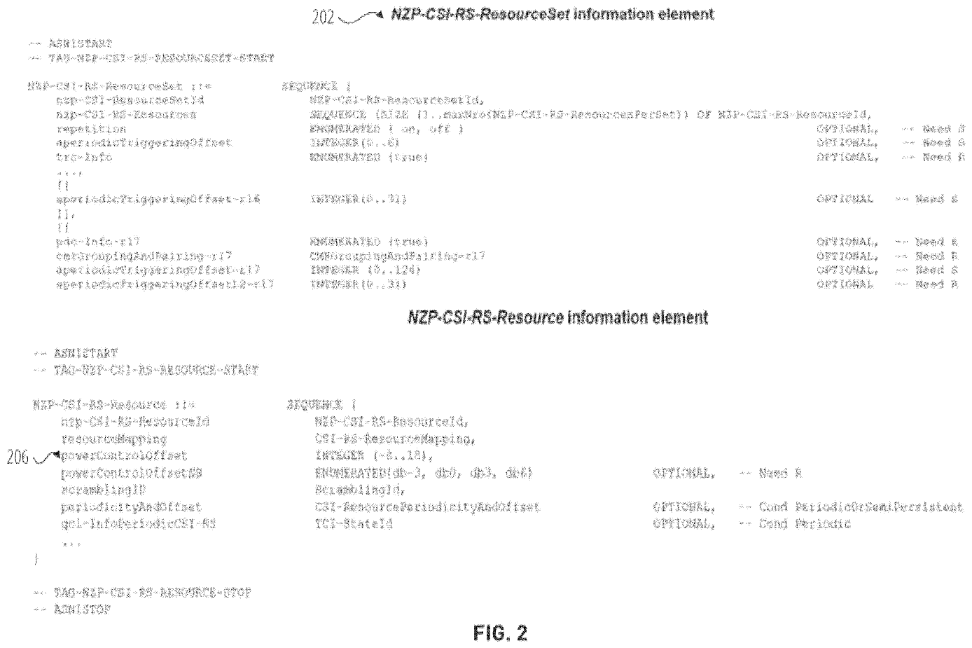

In some embodiments, the CSI resource sets configured by the CSI-ReportConfig information element 100 may include multiple resources. For example, FIG. 2 illustrates a CSI resource set information element 202 and a CSI-RS information element 204. The CSI resource set information element 202 may include multiple resources. The resources may be configured with the CSI-RS information element 204.

The CSI-RS information element 204 includes a powerControlOffset field 206. Within each CSI resource there may be a powerControlOffset field 206 that may include a power offset. The power offset may indicate an offset between the CSI-RS and the PDSCH. The UE may measure the CSI-RS and the UE may report information (e.g., CQI, PMI, RI) to the network based on the offset. The power control offset may be a single value. However, it may be advantageous for the UE to measure and report a CSI-RS using different power offsets.

In some embodiments, the network node may be able to dynamically adapt transmit power adaptation based on different situations. The UE may provide a CSI report corresponding to multiple different power offset values. Accordingly, some embodiments herein provide enhanced CSI measurement configuration and reporting to better support dynamic PDSCH power adaptation. Some embodiments provide detailed mechanisms for CSI-RS configuration. Some embodiments provide detailed mechanisms for CSI report configuration. Some embodiments provide detailed mechanisms for CSI overhead reduction. The embodiments may be generally applicable to periodic, semi-persistent and aperiodic CSI configuration and reporting.

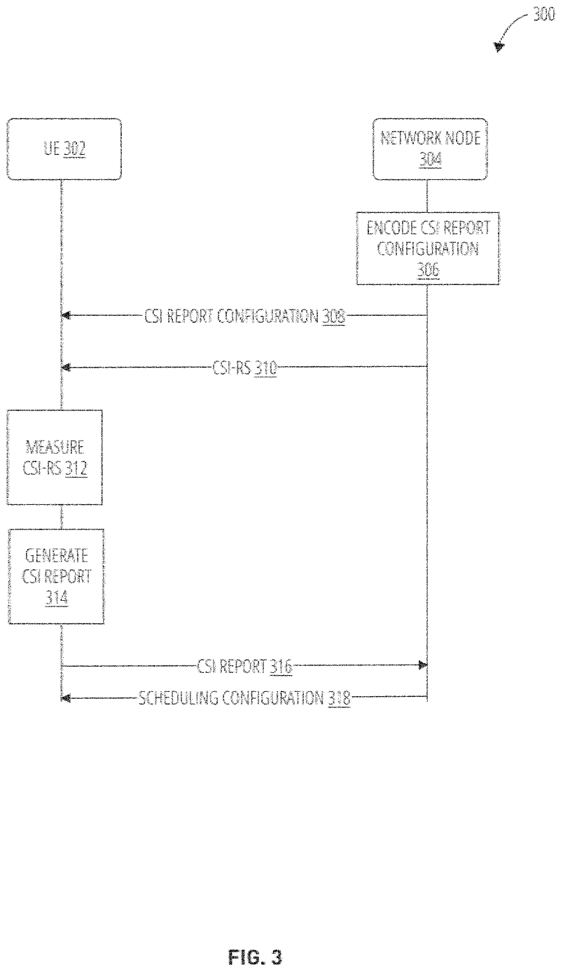

FIG. 3 illustrates a simplified signal flow diagram 300 for CSI reporting. As shown, the network node 304 may encode 306 a CSI report configuration information element. The network node 304 may transmit 308 the CSI report configuration information element to the UE 302. The network node 304 may also transmit 310 a CSI-RS to the UE.

The UE 302 may receive the CSI report configuration and measure 312 the CSI-RS. The UE may generate 314 a CSI report based on the measurement and the CSI report configuration. The CSI report may include CQI, PMI, and RI. The reported values may be based on a power offset included in the CSI report configuration. The UE 302 may transmit 316 the CSI report to the network node 304. The network node may configure 318 scheduling with the UE 302 based on the CSI report. In some embodiments, enhanced CSI measurement configuration and reporting may be used to better support dynamic PDSCH power adaptation.

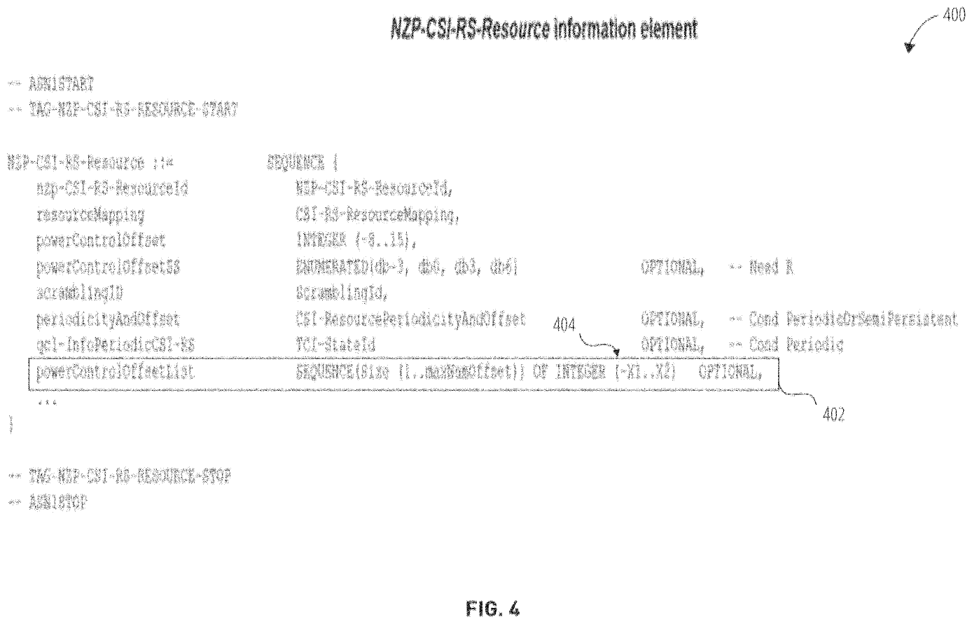

For example, the CSI report configuration may include a CSI-RS resource with a set of power control offset values. In some embodiments, a single CSI-reportConfig may link to at least a CSI-RS resource with a set of values for powerControlOffset. For example, FIG. 4 illustrates a CSI-RS information element 400 that includes a powerControlOffsetList 402 in accordance with some embodiments.

In some embodiments that use a powerControlOffsetList 402, there is no additional CSI-RS overhead, and the same CSI-RS resource may be used by the UE to perform a CSI measurement and report for multiple powerControlOffset values. The CSI-RS resource configuration (e.g., CSI-RS information element 400) may include additional parameters that configure a set of powerControlOffset (Power offset of PDSCH resource element (RE) to non-zero power (NZP) CSI-RS RE) values that are used by the UE for CSI measurement and reporting. The powerControlOffset values may be included in the powerControlOffsetList 402. In some embodiments, the value range 404 may be extended.

By using a CSI-RS information element 400 that lists multiple value offsets, the existing CSI report configuration may be reused. In other words, the existing CSI-ReportConfig information element is capable of linking to a CSI-RS resource with a set of values for powerControlOffset. This may increase compatibility and reduce implementation challenges.

The UE may perform CSI measurements and generate/transmit a report for one or multiple powerControlOffset values based on configurations or signaling indication. In some embodiments, the UE may report CSI for all or a subset of offsets from the list of powerControlOffset values. The UE may determine which of the powerControlOffset values to report in a variety of ways.

For example, in some embodiments, the powerControlOffset values that the UE is to report CSI for are based on an RRC configuration. In some embodiments, the UE reports CSI for all the powerControlOffset values configured in the CSI-RS resource. In some embodiments, the UE reports CSI only for one of the powerControlOffset values configured in the CSI-RS resource. For example, the UE may report the CSI for the first offset value or the last offset value, unless indicated otherwise. The network node may indicate which power control offset value the UE is to report CSI for if another value besides the default value (e.g., the first offset value or the last offset value) is desired. The offset values for which the UE is to report CSI can be applied to periodic CSI report, or by default to other types of CSI report.

In some embodiments, the powerControlOffset values that the UE is to report CSI for are indicated in a medium access control (MAC) control element (CE). The network node can use a MAC CE to indicate to the UE for which powerControlOffset values to report CSI. In some embodiments, a bitmap may be used to indicate the desired powerControlOffset values. For example, the MAC CE can include a bitmap with each bit indicating whether a powerControlOffset value corresponding to the bit is activated for CSI reporting.

For example, the network may configure a bitmap and inform the UE of which bits in the bitmap correspond to which powerControlOffset values for a CSI-RS resource. Based on the relationships, the network node may send a bitmap to the UE to indicate the offset values for which the UE is to report CSI. For example, the network node may set one or more bits in the bitmap to 1 to indicate that the UE should report CSI for powerControlOffset values corresponding to those bits. The network node may send the bitmap to the UE via a MAC CE. When the UE receives the bitmap it may determine which powerControlOffset values correspond to the bits of the bitmap set to 1. The UE may report, to the network node, CSI for those corresponding powerControlOffset values.

In some embodiments, the length of the bitmap may be equal to the number of configured powerControlOffset values for the CSI-RS resource. For example, FIG. 5 illustrates MAC CE fields 500 where a first CSI-RS resource 502 corresponds to a first bitmap 504 and a second CSI-RS resource 506 corresponds to a second bitmap 508. Accordingly, the first bitmap 504 may have a length equal to the number of powerControlOffset values for the first CSI-RS resource 502. The second bitmap 508 may have a length equal to the number of powerControlOffset values for the second CSI-RS resource 506.

In some embodiments, the length of the bitmap can be equal to the maximum number of configured powerControlOffset values among all the CSI-RS resources. For example, the first bitmap 504 and the second bitmap 508 may have a length equal to the greater of the number of powerControlOffset values for the first CSI-RS resource 502 and the number of powerControlOffset values for the second CSI-RS resource 506.

In some embodiments, a table can be configured for a CSI-RS resource where each index of the table points to a list of powerControlOffset values. In this way, each index of the table may be used by the network node to indicate one or multiple powerControlOffset values. In some embodiments, a bitmap may be used to configure each entry of the table where each bit of a bitmap corresponds to one powerControlOffset value. An index from the table may be included in a MAC CE to indicate to the UE the corresponding list of powerControlOffset values for which the UE is to report CSI.

In some embodiments, an index can be defined for each powerControlOffset value, and the network node uses one or more indices to indicate the powerControlOffset values for which the UE is to report CSI.

For semi-persistent CSI report on Physical Uplink Control Channel (PUCCH), the bitmap, index, or indices can be added as new fields in the existing semi-persistent CSI reporting on PUCCH Activation/Deactivation MAC CE.

In some embodiments, the UE determine which powerControlOffset values to report CSI for based on powerControlOffset values directly within the MAC CE. The network may provide to the UE one or more powerControlOffset values for the CSI-RS resource(s) within the MAC CE. The UE may use the MAC CE to update the list of powerControlOffset values for the CSI-RS resource(s).

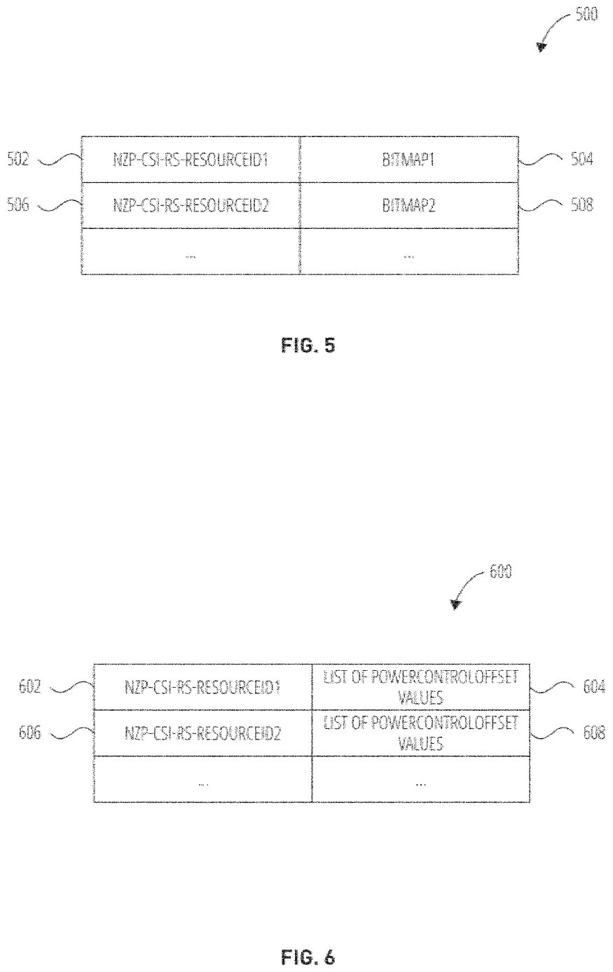

Instead of configuring a superset for the potential powerControlOffset values as part of CSI-RS resource configuration and use MAC CE to activate/deactivate, the network can alternatively use MAC CE to directly update the list of powerControlOffset values for the CSI-RS resource(s). For example, FIG. 6 illustrates MAC CE fields 600 that may be used to directly update the list of powerControlOffset values for the CSI-RS resource(s). As shown, the MAC CE fields 600 includes a first list 604 of offset values for a first CSI-RS resource 602 and a second list 608 of offset values for a second CSI-RS resource 606. The offset value lists (e.g., first list 604 and second list 608) may include power offset values (e.g., 0 dB, 9 dB, etc.) for the corresponding CSI-RS resource. For semi-persistent CSI report on PUCCH, these fields can be added as new fields in the existing semi-persistent CSI reporting on PUCCH Activation/Deactivation MAC CE.

In some embodiments, the UE may determine which powerControlOffset values to report CSI for based on a dynamic indication in downlink control information (DCI) for aperiodic CSI report or semi-persistent CSI report on PUSCH. Both aperiodic CSI report and semi-persistent CSI report on PUSCH are triggered by DCI, and the corresponding indication can be carried in the triggering DCI. In some embodiments, the indication in the DCI may be a bitmap where each bit corresponds to one or more powerControlOffset values as previously discussed. In some embodiments, the indication in the DCI may be an index to a table, the index corresponding to one or more powerControlOffset values as previously discussed. In some embodiments, the indication in the DCI may be one or more indices, with each index corresponding to one powerControlOffset value as previously discussed. A single index may be used in this case to save DCI overhead.

Because overhead is an important consideration for DCI, in some embodiments some information may be omitted. For example, to save DCI overhead, NZP-CSI-RS-ResourceId may be omitted. When the NZP-CSI-RS-ResourceId is omitted there may be only one CSI-RS resource with multiple configured powerControlOffset values in the triggered CSI report. If there is only one CSI-RS resource, the NZP-CSI-RS-ResourceId may not be needed to identify which CSI-RS resource the powerControlOffset values correspond to.

The content of the CSI report sent from the UE to the network node may include information from the CSI-RS measurements for the powerControlOffset values. In some embodiments, the same reportQuantity (e.g. cri-RI-PMI-CQI, cri-RI-CQI) is reported for each powerControlOffset value separately. The UE may concatenate the reportQuantity values in the CSI report. The concatenation of the reportQuantity values may be ordered such that the network node may identify which value corresponds to which powerControlOffset value. For example, for reportQuantity of cri-RI-PMI-CQI, in some embodiments the report may concatenate the CSI-RS Resource Indicator (CRI), RI, PMI, and CQI of each power offset together (e.g., CRI1, RI1, PMI1, CQI1, CRI2, RI2, PMI2, CQI2 where the 1 indicates a first control power offset and the 2 represents a second power control offset). In some embodiments, the same reportQuantity may be concatenated together (e.g., cri1, cri2, RI1, RI2, PMI1, PMI2, CQI1, CQI2 where the 1 indicates a first control power offset and the 2 represents a second power control offset).

In some embodiments, one or more measurement(s) may be commonly reported for all powerControlOffset values in the CSI report, while the remaining measurement(s) are separately reported for each powerControlOffset value. By commonly reporting some measurements, the CSI report overhead may be reduced. Provided below are examples of CSI report content that includes commonly reported measurements. However, these are just a few examples, there may be other possibilities. Which measurement(s) are commonly reported and which measurement(s) are separately reported can be pre-defined in the specifications, or configured by the network node. In some embodiments, the measurements to be reported commonly may be based on the configured offsets.

For example, for reportQuantity of cri-RI-PMI-CQI, in some embodiments, CRI, RI, PMI may be commonly reported for all powerControlOffset values, while CQI is separately reported for each powerControlOffset value. In some embodiments, for reportQuantity of cri-RI-CQI, CRI may be commonly reported for all powerControlOffset values, while RI and CQI are separately reported for each powerControlOffset value. With different power levels RI and CQI may vary based on the powerControlOffset value.

In some embodiments, RI may be separately reported for each powerControlOffset value, and PMI may be commonly reported for all powerControlOffset values. However, the actual precoder matrix for each powerControlOffset value may be determined based on the reported PMI and the corresponding RI (r), where only the first r precoding vectors for the reported PMI are effective. For example, for r=4, the first four precoding vectors for the reported PMI may be used even when there are additional precoding vectors for the reported PMI. For different powerControlOffset values, it is typical that the best precoding vector(s) are the same. For smaller powerControlOffset, it may be better to use a smaller rank. The bit width for PMI may be determined based on the maximum RI among all powerControlOffset values.

In some embodiments, a single CSI-reportConfig may link to multiple CSI-RS resource sets. Each CSI-RS resource set may include at least a CSI-RS resource with different settings for powerControlOffsetSS and optionally different settings for powerControlOffset. PowerControlOffsetSS is an offset of CSI-RS transmission power relative to SS/PBCH block transmission power.

Using multiple CSI-RS resource sets may allow the network node to have a different transmit power for the CSI-RS resources. This can be useful if a different transmit power for CSI-RS is needed for UE to estimate the CSI for different PDSCH transmit power, especially if the dynamic range of PDSCH transmit power is large. For example, if the network node were to use a low power CSI-RS for estimation of a high power PDSCH transmission, the CSI may not be accurate. Therefore, using different powerControlOffsetSS may allow for greater flexibility to handle such scenarios.

The CSI-RS resource set configuration may facilitate different settings for powerControlOffsetSS and optionally different settings for powerControlOffset. CSI-RS resources in different CSI-RS resource sets may have different values for powerControlOffsetSS, which reflects different transmit power for the CSI-RS resources. Each CSI-RS resource may include one or multiple powerControlOffset values that are used by the UE for CSI measurement and reporting.

This means that one CSI-RS resource may be used for the CSI report for multiple PDSCH transmit power levels, and the number of CSI-RS resources may be less than the number of PDSCH transmit power levels to be reported. For example, the CSI-report may be configured for four levels of transmit powers. Two CSI-RS resources may be configured with different PowerControlOffsetSS values. Within each CSI-RS resource two powerControlOffset values may be configured. In this example, the number of CSI-RS resources would be two while the number of PDSCH transmit power levels to be reported would be four because each CSI-RS resource includes two powerControlOffset values.

Each CSI-RS resource may be independently configured. This means that each CSI-RS resource may have different time and/or frequency resources, different periodicities in time, etc. Embodiments with multiple CSI-RS resource sets may require adjustments of certain limitations. For example, this approach may require lifting of the current limitation of only one CSI-RS resource set for periodic and semi-persistent CSI reporting. In some embodiments, the existing CSI-ReportConfig can be reused. The UE may perform CSI measurement and report for one or multiple CSI-RS resource sets based on configurations or signaling indication.

For embodiments that include multiple CSI-RS resource sets, several options may be implemented for the UE to determine which CSI-RS resource set(s) to report CSI. In some embodiments, the UE may determine which resource to report CSI for based on RRC configuration. In some embodiments, the UE reports CSI for all the configured CSI-RS resource sets.

In some embodiments, the UE reports CSI only for one of the multiple configured CSI-RS resource sets. For example, the UE may report the CSI for the first configured CSI-RS resource set or the last configured CSI-RS resource set, unless indicated otherwise. The network node may indicate which configured CSI-RS resource set that the UE is to report CSI for if another value besides the default value (e.g., the first or the last) is desired. The configured CSI-RS resource set for which the UE is to report CSI can be applied to a periodic CSI report, or by default to other types of CSI report.

In some embodiments, the CSI-RS resource set(s) that the UE is to report CSI for are indicated in a MAC CE. The network node can use a MAC CE to indicate to the UE for which CSI-RS resource sets to report CSI. In some embodiments, a bitmap may be used to indicate the desired CSI-RS resource sets. For example, the MAC CE can include a bitmap with each bit indicating whether a CSI-RS resource set corresponding to the bit is activated for CSI reporting.

For example, the network may configure a bitmap and inform the UE of which bits in the bitmap correspond to which CSI-RS resource sets. Based on the relationships, the network node may send a bitmap to the UE to indicate the CSI-RS resource sets for which the UE is to report CSI. For example, the network node may set one or more bits in the bitmap to 1 to indicate that the UE should report CSI for CSI-RS resource sets corresponding to those bits. The network node may send the bitmap to the UE via an MAC CE. When the UE receives the bitmap it may determine which CSI-RS resource sets correspond to the bits of the bitmap set to 1. The UE may report, to the network node, CSI for power control offsets of corresponding CSI-RS resource set. In some embodiments, the length of the bitmap may be equal to the number of configured CSI-RS resource sets.

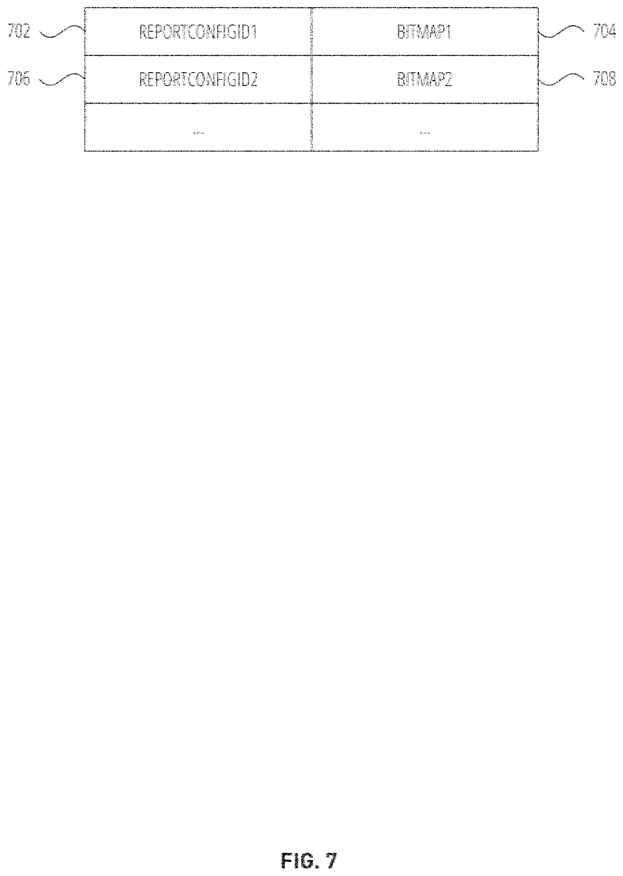

In some embodiments, the length of the bitmap can be equal to the maximum number of configured CSI-RS resource sets across the CSI report configurations. For example, FIG. 7 illustrates MAC CE fields where a first CSI report configuration 702 corresponds to a first bitmap 704 and a second CSI report configuration 706 corresponds to a second bitmap 708. The length of the first bitmap 704 and the second bitmap 708 can be equal to the maximum number of configured CSI-RS resource sets across the CSI report configurations (e.g., first CSI report configuration 702 and second CSI report configuration 706).

In some embodiments, a table can be configured for a CSI report configuration where each index of the table points to a list of CSI-RS resource sets. In this way, each index of the table may be used by the network node to indicate one or multiple CSI-RS resource sets. In some embodiments, a bitmap may be used to configure each entry of the table where each bit of a bitmap corresponds to one CSI-RS resource set. An index from the table may be included in a MAC CE to indicate to the UE the corresponding list of CSI-RS resource sets for which the UE is to report CSI.

In some embodiments, one index can be associated with each CSI-RS resource set, and the network node uses one or more indices to indicate the CSI-RS resource sets for which the UE is to report CSI. The index may be the existing nzp-CSI-ResourceSetId, or separately defined.

For semi-persistent CSI report on Physical Uplink Control Channel (PUCCH), the bitmap, index, or indices can be added as new fields in the existing semi-persistent CSI reporting on PUCCH Activation/Deactivation MAC CE.

In some embodiments, the UE may determine which CSI-RS resource set(s) to report CSI for based on a dynamic indication in DCI for aperiodic CSI report or semi-persistent CSI report on PUSCH. Both aperiodic CSI report and semi-persistent CSI report on PUSCH are triggered by DCI, and the corresponding indication can be carried in the triggering DCI. In some embodiments, the indication in the DCI may be a bitmap where each bit corresponds to one or more CSI-RS resource set(s). In some embodiments, the indication in the DCI may be an index to a table, the index corresponding to one or more CSI-RS resource set(s). In some embodiments, the indication in the DCI may be one or more indices, with each index corresponding to one CSI-RS resource set as previously discussed. A single index may be used in this case to save DCI overhead.

Because overhead is an important consideration for DCI, in some embodiments some information may be omitted. For example, to save DCI overhead, reportConfigId may be omitted. When the reportConfigId is omitted there may be only one CSI-ReportConfig with multiple configured CSI-RS resource sets in the triggered CSI report. If there is only one CSI-RS resource set, the CSI-ResourceConfigId may not be needed. In some embodiments, the network can indicate one or more CSI-RS resource sets and also indicate a set of powerControlOffset values (as previously discussed) for each CSI-RS resource within the CSI-RS resource set that has multiple powerControlOffset values for UE to report CSI.

The content of the CSI report sent from the UE to the network node may include information from the CSI-RS measurements. In some embodiments, the same reportQuantity (e.g. cri-RI-PMI-CQI, cri-RI-CQI) is reported for each CSI-RS resource set value separately. The UE may concatenate the reportQuantity values in the CSI report. The concatenation of the reportQuantity values may be ordered such that the network node may identify which value corresponds to which CSI-RS resource set. For example, for reportQuantity of cri-RI-PMI-CQI, in some embodiments the report may concatenate the CRI, RI, PMI, and CQI of each power offset together (e.g., CRI1, RI1, PMI1, CQI1, CRI2, RI2, PMI2, CQI2 where the 1 indicates a first CSI-RS resource set and the 2 represents a second p=CSI-RS resource set). In some embodiments, the same reportQuantity may be concatenated together (e.g., CRI1, CRI2, RI1, RI2, PMI1, PMI2, CQI1, CQI2 where the 1 indicates a first CSI-RS resource set and the 2 represents a second CSI-RS resource set).

In some embodiments, one or more measurement(s) may be commonly reported for all CSI-RS resource sets, while the remaining measurement(s) are separately reported for each CSI-RS resource set. By commonly reporting some measurements, the CSI report overhead may be reduced. Provided below are examples of CSI report content that includes commonly reported measurements. However, these are just a few examples, there may be other possibilities. Which measurement(s) are commonly reported and which measurement(s) are separately reported can be pre-defined in the specifications, or configured by the network node.

For example, for reportQuantity of cri-RI-PMI-CQI, in some embodiments, CRI, RI, PMI may be commonly reported for all CSI-RS resource sets, while CQI is separately reported for each CSI-RS resource set. In some embodiments, for reportQuantity of cri-RI-CQI, CRI may be commonly reported for all CSI-RS resource sets, while RI and CQI are separately reported for each CSI-RS resource set.

In some embodiments, RI may be separately reported for each CSI-RS resource set value, and PMI may be commonly reported for all CSI-RS resource sets. However, the actual precoder matrix for each CSI-RS resource set may be determined based on the reported PMI and the corresponding RI (r), where only the first r precoding vectors for the reported PMI are effective. For different transmit power for CSI-RS and/or PDSCH, the best precoding vector(s) can be the same. However, it may be better to use different rank. The bit width for PMI may be determined based on the maximum RI among all CSI-RS resource sets.

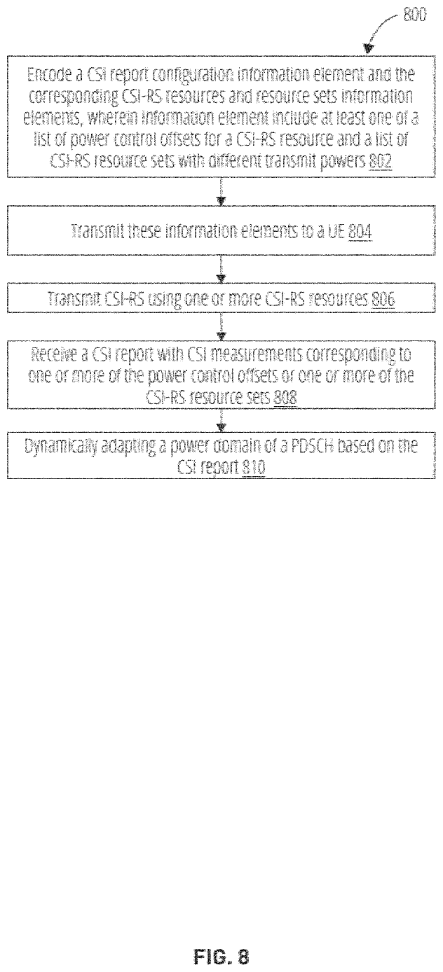

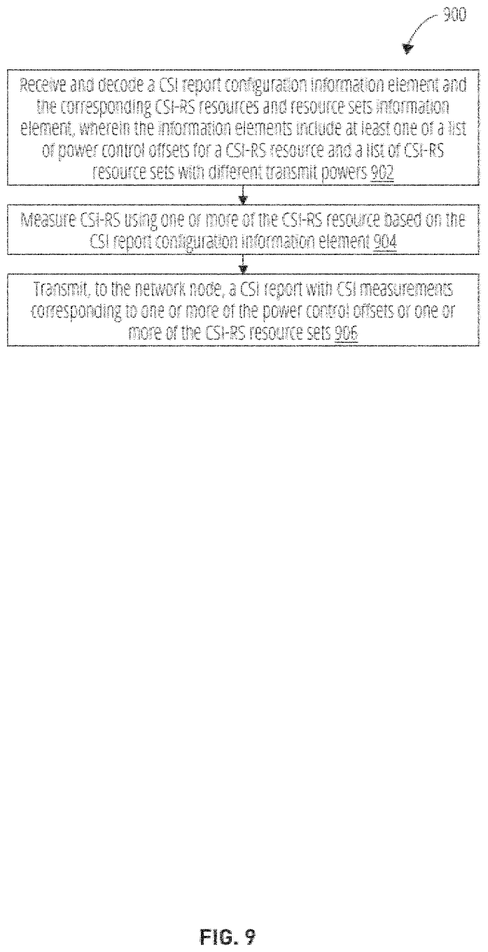

FIG. 8 illustrates a flowchart of a method 800 for a network node according to embodiments herein. The method 800 includes encoding 802 a CSI report configuration information element and the corresponding CSI-RS resources and resource sets information elements, wherein the information elements include at least one of a list of power control offsets for a CSI-RS resource and a list of CSI-RS resource sets with different transmit powers, transmitting 804 these information elements to a UE, transmitting 806 CSI-RS using the one or more CSI-RS resources, receiving 808 a CSI report with CSI measurements corresponding to one or more of the power control offsets or one or more of the CSI-RS resource sets, and dynamically adapting 810 a power domain of a PDSCH based on the CSI report.

In some embodiments of the method 800, the CSI report configuration information element links to a CSI-RS resource with a set of powerControlOffset values indicating a power offset of PDSCH RE to CSI-RS RE.

In some embodiments, the method 800 further comprises sending a RRC configuration to the UE to indicate the power control offsets for which the UE should report the CSI measurements.

In some embodiments, the method 800 further comprises sending a MAC CE comprising a bitmap that indicates the power control offsets for which the UE should report the CSI measurements.

In some embodiments, the method 800 further comprises sending a MAC CE comprising an index that indicates one or multiple of the power control offsets for which the UE should report the CSI measurements.

In some embodiments, the method 800 further comprises sending a MAC CE comprising one or more indices, with each index indicating one power control offset for which the UE should report the CSI measurements.

In some embodiments, the method 800 further comprises sending DCI to the UE to indicate the power control offsets for which the UE should report CSI measurements.

In some embodiments, the method 800 further comprises using a MAC CE to update the power control offsets.

In some embodiments of the method 800, the CSI report comprises measurements for each of the power control offsets separately in the CSI report, wherein the measurements are concatenated in the CSI report.

In some embodiments of the method 800, one or more CSI measurements are commonly reported for all of the power control offsets, while remaining CSI measurements are separately reported for each of the power control offsets.

In some embodiments of the method 800, the CSI report configuration information element links to multiple CSI-RS resource sets, each of the multiple CSI-RS resource sets comprise a CSI-RS resource with different settings for a powerControlOffsetSS field which reflects a different transmit power for the CSI-RS resources.

FIG. 9 illustrates a flowchart of a method 900 for a UE according to embodiments herein. The method 900 includes receiving and decoding 902 a CSI report configuration information element and the corresponding CSI-RS resources and resource sets information element, wherein the information elements include at least one of a list of power control offsets for a CSI-RS resource and a list of CSI-RS resource sets with different transmit powers. The method 900 further includes measuring 904 CSI-RS using one or more of the CSI-RS resources based on the CSI report configuration information element, and transmitting 906, to the network node, a CSI report with CSI measurements corresponding to one or more of the power control offsets or one or more of the CSI-RS resource sets.

Within some embodiments of the method 900, the CSI report configuration information element links to a CSI-RS resource with a set of powerControlOffset values indicating a power offset of PDSCH RE to CSI-RS RE.

Within some embodiments, the method 900 further comprises receiving a RRC configuration to the UE to indicate the power control offsets for which the UE should report the CSI measurements.

Within some embodiments, the method 900 further comprises receiving a MAC CE comprising a bitmap that indicates the power control offsets for which the UE should report the CSI measurements.

Within some embodiments, the method 900 further comprises receiving a MAC CE comprising an index that indicates one or multiple of the power control offsets for which the UE should report the CSI measurements.

In some embodiments, the method 900 further comprises receiving a MAC CE comprising one or more indices, with each index indicating one power control offset for which the UE should report the CSI measurements.

Within some embodiments, the method 900 further comprises receiving a DCI to the UE to indicate the power control offsets for which the UE should report CSI measurements.

Within some embodiments, the method 900 further comprises receiving a MAC CE configured to update the power control offsets.

Within some embodiments of the method 900, the CSI report comprises measurements for each of the power control offsets separately in the CSI report, wherein the measurements are concatenated in the CSI report.

Within some embodiments of the method 900, one or more CSI measurements are commonly reported for all of the power control offsets, while remaining CSI measurements are separately reported for each of the power control offsets.

Within some embodiments of the method 900, the CSI report configuration information element links to multiple CSI-RS resource sets, each of the multiple CSI-RS resource sets comprise a CSI-RS resource with different settings for a powerControlOffsetSS field which reflects a different transmit power for the CSI-RS resources.

In some embodiments, multiple CSI report configurations may be used to support multiple PDSCH transmit powers. The CSI-RS resources in the multiple CSI-reportConfig may have different settings for powerControlOffset and/or powerControlOffsetSS.

The CSI-RS resources for the multiple CSI-reportConfig's may refer to the same physical CSI-RS signal, even though the powerControlOffset value can be different. This would configure the UE to perform measurements on the same CSI-RS resource for multiple powerControlOffset values. The resulting CSI report would provide feedback to the network concerning the resource at those different power control offset values, and the network node would be able to adjust resources for future scheduling based on that feedback.

These multiple CSI-reportConfigs may link to different CSI-RS resources, where they may have different transmit power (i.e., different powerControlOffsetSS). Different transmit power for CSI-RS can be beneficial for UE to estimate the CSI for different PDSCH transmit power, especially if the dynamic range of PDSCH transmit power is large.

In some embodiments, existing IEs can be reused. For example, the existing NZP-CSI-RS-Resource can be reused. Further, in some embodiments, the existing CSI-ReportConfig can be reused. In this case, each CSI-ReportConfig may be independently configured, and can be independently triggered using a legacy triggering mechanism.

In some embodiments, the multiple CSI-reportConfig information elements may be configured as a group. Further, there may be certain restrictions and limitations in the configuration, triggering, and reporting. For example, the multiple CSI-reportConfig information elements may have the same reportQuantity, reportFreqConfiguration, timeRestrictionForChannelMeasurements, timeRestrictionForInterferenceMeasurements, cqi-Table, and/or subbandSize. Another example of a restriction may be that the CSI resource sets corresponding to the multiple CSI-reportConfig information elements have the same values for some parameters (e.g., periodicity, number of ports, CSI-RS-ResourceMapping, and/or CSI-FrequencyOccupation.)

In some embodiments, when multiple of these CSI-ReportConfigs are reported simultaneously, the content of CSI report may be reduced to optimize the reporting process. Some measurement(s) may be commonly reported for the multiple CSI-reportConfigs, while the remaining measurement(s) are separately reported for each CSI-reportConfig. This can reduce the CSI report overhead.

For example, for reportQuantity of cri-RI-PMI-CQI, CRI, RI, and PMI may be commonly reported for the multiple CSI-reportConfigs, while CQI may be separately reported for each CSI-reportConfig. As another example, for reportQuantity of cri-RI-CQI, CRI may be commonly reported for the multiple CSI-reportConfigs, while RI and CQI may be separately reported for each CSI-reportConfig. As yet another example, RI may be separately reported for each CSI-reportConfig, and PMI may be commonly reported for these multiple CSIreportConfigs. However, the actual precoder matrix for each CSI-reportConfig may be determined based on the reported PMI and the corresponding RI (r), where only the first r precoding vectors for the reported PMI are effective. These are just a few examples, and there are many other possibilities. Which measurement(s) are commonly reported and which measurement(s) are separately reported can be pre-defined in the specification, or configured by the network node.

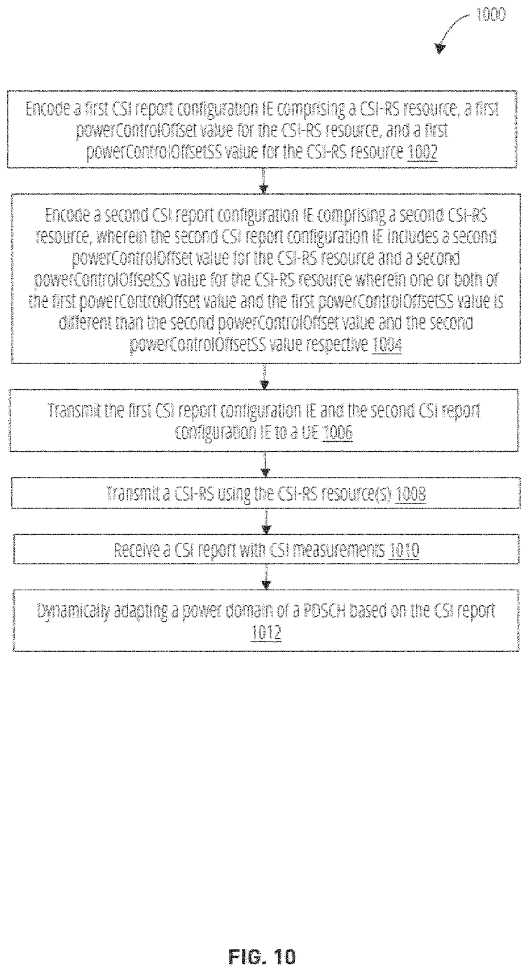

FIG. 10 illustrates a flowchart of a method 1000 for a network node according to embodiments herein. The method 1000 includes encoding 1002 a first CSI report configuration IE comprising at least a CSI-RS resource, a first powerControlOffset value for the CSI-RS resource, and a first powerControlOffsetSS value for the CSI-RS resource. The illustrated method 1000 further includes encoding 1004 a second CSI report configuration IE comprising at least a second CSI-RS resource, wherein the second CSI report configuration IE includes a second powerControlOffset value for the CSI-RS resource and a second powerControlOffsetSS value for the CSI-RS resource wherein one or both of the first powerControlOffset value and the first powerControlOffsetSS value is different than the second powerControlOffset value and the second powerControlOffsetSS value respectively. The illustrated method 1000 further includes transmitting 1006 the first CSI report configuration IE and the second CSI report configuration IE to a UE, transmitting 1008 CSI-RS using the CSI-RS resource(s), receiving 1010 a CSI report with CSI measurements, and dynamically adapting 1012 a power domain of a PDSCH based on the CSI report.

Within some embodiments of the method 1000, the first CSI report configuration IE and the second CSI report configuration IE have equal values for some parameters. In some embodiments, the first CSI report configuration IE and the second CSI report configuration IE have one or more of a same reportQuantity, a same reportFreqConfiguration, a same timeRestrictionForChannelMeasurements, a same timeRestrictionForInterferenceMeasurements, a same cqi-Table, and a same subbandSize.

Within some embodiments of the method 1000, the CSI resource sets corresponding to the first CSI report configuration IE and the second CSI report configuration IE include equal values for some parameters. In some embodiments, the CSI resource sets corresponding to the first CSI report configuration IE and the second CSI report configuration IE have one or more of a same periodicity, a same number of ports, a same CSI-RS-ResourceMapping, and a same CSI-FrequencyOccupation.

Within some embodiments of the method 1000, when the CSI reports for the first and the second report configurations are transmitted simultaneously, some of the CSI measurements are commonly reported for the first CSI report configuration IE and the second CSI report configuration IE, while the remaining measurements are separately reported for each of the first CSI report configuration IE and the second CSI report configuration IE. Some such embodiments further comprise configuring which of the CSI measurements are commonly reported and which of the CSI measurements are separately reported. In some such embodiments, CRI, PMI, and RI are commonly reported for the first CSI report configuration IE and the second CSI report configuration IE, and wherein CQI is separately reported for the first CSI report configuration IE and the second CSI report configuration IE.

Within some embodiments of the method 1000, CRI is commonly reported for the first CSI report configuration IE and the second CSI report configuration IE, and wherein CQI and RI are separately reported for the first CSI report configuration IE and the second CSI report configuration IE.

Within some embodiments of the method 1000, PMI is commonly reported for the first CSI report configuration IE and the second CSI report configuration IE, and wherein RI is separately reported for the first CSI report configuration IE and the second CSI report configuration IE.

Within some embodiments, the method 1000 further comprises encoding and sending additional CSI report configuration IEs comprising the CSI-RS resource, additional powerControlOffset values for the CSI-RS resource, and additional powerControlOffsetSS values for the CSI-RS resource.

Embodiments contemplated herein include an apparatus comprising means to perform one or more elements of the method 800 and method 1000. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 800 and method 1000. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 800 and method 1000. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 800 and method 1000. This apparatus may be, for example, an apparatus of a base station (such as a network device 1318 that is a base station, as described herein).

Embodiments contemplated herein include a signal as described in or related to one or more elements of the method 800 and method 1000.

Embodiments contemplated herein include a computer program or computer program product comprising instructions, wherein execution of the program by a processing element is to cause the processing element to carry out one or more elements of the method 800 and method 1000. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

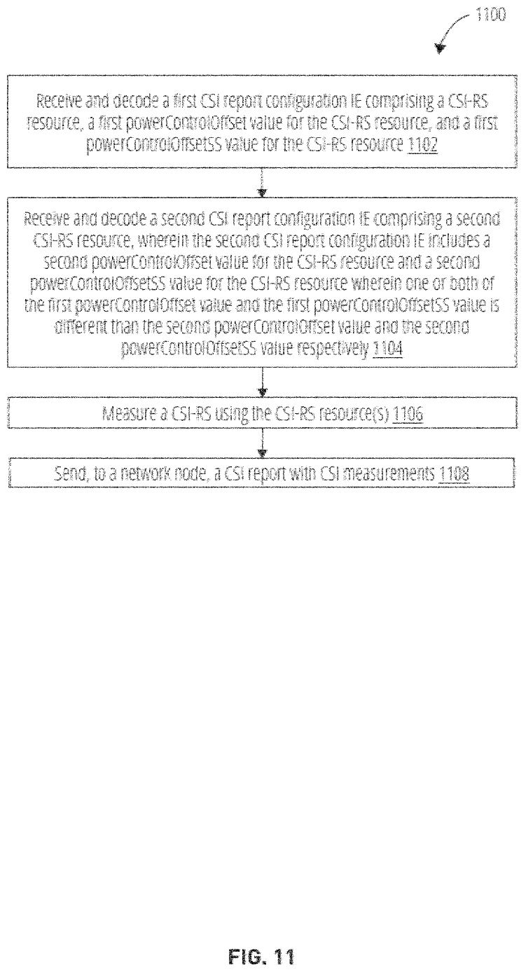

FIG. 11 illustrates a flowchart of a method 1100 for a UE according to embodiments herein. The method 1100 includes receiving and decoding 1102, a first CSI report configuration IE comprising a CSI-RS resource, a first powerControlOffset value for the CSI-RS resource, and a first powerControlOffsetSS value for the CSI-RS resource, receiving and decoding 1104 a second CSI report configuration IE comprising a second CSI-RS resource, wherein the second CSI report configuration IE includes a second powerControlOffset value for the CSI-RS resource and a second powerControlOffsetSS value for the CSI-RS resource wherein one or both of the first powerControlOffset value and the first powerControlOffsetSS value is different than the second powerControlOffset value and the second powerControlOffsetSS value respectively. The method 1100 further includes measuring 1106 CSI-RS using the CSI-RS resource(s), and sending 1108 to a network node, a CSI report with CSI measurements.

Within some embodiments of the method 1100, the first CSI report configuration IE and the second CSI report configuration IE have one or more of a same reportQuantity, a same reportFreqConfiguration, a same timeRestrictionForChannelMeasurements, a same timeRestrictionForInterferenceMeasurements, a same cqi-Table, and a same subbandSize.

Within some embodiments of the method 1100, the CSI resource sets corresponding to the first CSI report configuration IE and the second CSI report configuration IE include equal values for some parameters.

Within some embodiments of the method 1100, when the CSI reports for the first and the second report configurations are transmitted simultaneously, some of the CSI measurements are commonly reported for the first CSI report configuration IE and the second CSI report configuration IE, while the remaining measurements are separately reported for each of the first CSI report configuration IE and the second CSI report configuration IE. Some such embodiments further comprise, determining which of the CSI measurements are commonly reported and which of the CSI measurements are separately reported. Within some such embodiments, CRI, PMI, and RI are commonly reported for the first CSI report configuration IE and the second CSI report configuration IE, and wherein CQI is separately reported for the first CSI report configuration IE and the second CSI report configuration IE.

Within some embodiments of the method 1100, CRI is commonly reported for the first CSI report configuration IE and the second CSI report configuration IE, and wherein CQI and RI are separately reported for the first CSI report configuration IE and the second CSI report configuration IE.

Within some embodiments of the method 1100, PMI is commonly reported for the first CSI report configuration IE and the second CSI report configuration IE, and wherein RI is separately reported for the first CSI report configuration IE and the second CSI report configuration IE.

Within some embodiments, the method 1100 further comprises receiving and decoding additional CSI report configuration IEs comprising the CSI-RS resource, additional powerControlOffset values for the CSI-RS resource, and additional powerControlOffsetSS values for the CSI-RS resource.

Embodiments contemplated herein include an apparatus comprising means to perform one or more elements of the method 900 and method 1100. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the method 900 and method 1100. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the method 900 and method 1100. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the method 900 and method 1100. This apparatus may be, for example, an apparatus of a UE (such as a wireless device 1302 that is a UE, as described herein).

Embodiments contemplated herein include a signal as described in or related to one or more elements of the method 900 and method 1100.

Embodiments contemplated herein include a computer program or computer program product comprising instructions, wherein execution of the program by a processor is to cause the processor to carry out one or more elements of the method 900 and method 1100. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

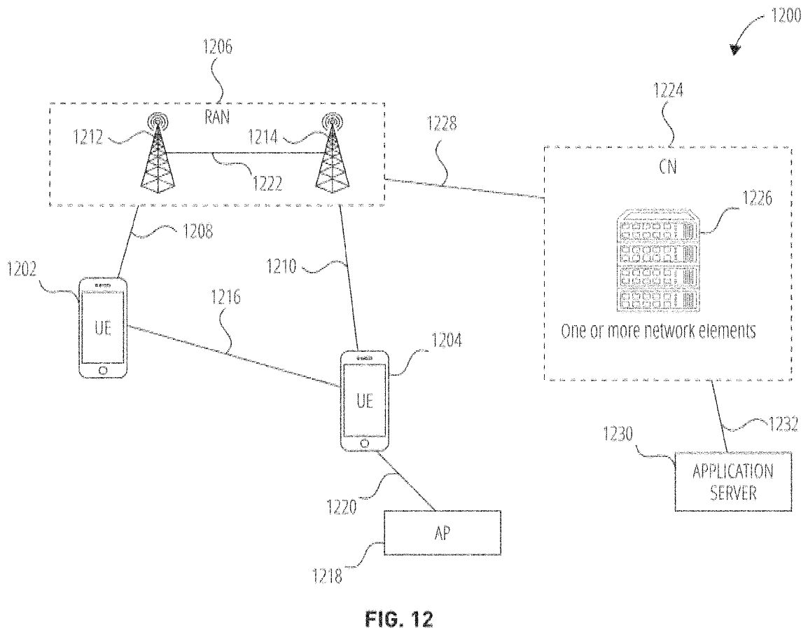

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VOIP sessions, group communication sessions, etc.) for the UE 1202 and UE 1204 via the CN 1224. The application server 1230 may communicate with the CN 1224 through an IP communications interface 1232.

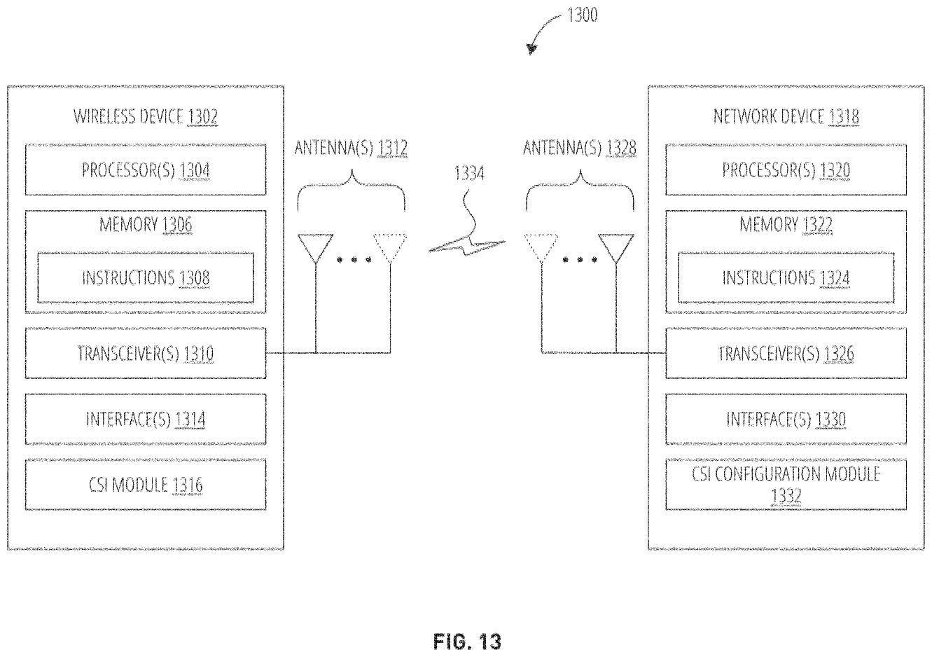

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a CSI module 1316. The CSI module 1316 may be implemented via hardware, software, or combinations thereof. For example, the CSI module 1316 may be implemented as a processor, circuit, and/or instructions 1308 stored in the memory 1306 and executed by the processor(s) 1304. In some examples, the CSI module 1316 may be integrated within the processor(s) 1304 and/or the transceiver(s) 1310. For example, the CSI module 1316 may be implemented by a combination of software components (e.g., executed by a DSP or a general processor) and hardware components (e.g., logic gates and circuitry) within the processor(s) 1304 or the transceiver(s) 1310.

The CSI module 1316 may be used for various aspects of the present disclosure, for example, aspects of FIGS. 3-7, 9, and 11. The CSI module 1316 is configured to receive and decode a CSI report configuration IE and measure and report CSI according to the CSI report configuration IE.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include a CSI configuration module 1332. The CSI configuration module 1332 may be implemented via hardware, software, or combinations thereof. For example, the CSI configuration module 1332 may be implemented as a processor, circuit, and/or instructions 1324 stored in the memory 1322 and executed by the processor(s) 1320. In some examples, the CSI configuration module 1332 may be integrated within the processor(s) 1320 and/or the transceiver(s) 1326. For example, the CSI configuration module 1332 may be implemented by a combination of software components (e.g., executed by a DSP or a general processor) and hardware components (e.g., logic gates and circuitry) within the processor(s) 1320 or the transceiver(s) 1326.

The CSI configuration module 1332 may be used for various aspects of the present disclosure, for example, aspects of FIGS. 3-8, and 10. The CSI configuration module 1332 is configured to encode a CSI report configuration information element.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
encoding a first Channel State Information (CSI) report configuration information element (IE) comprising a first CSI-Reference signal (RS) resource, a first powerControlOffset value for the first CSI-RS resource, and a first powerControlOffsetSS value for the first CSI-RS resource;
encoding a second CSI report configuration IE comprising a second CSI-RS resource, wherein the second CSI report configuration IE includes a second powerControlOffset value for the second CSI-RS resource and a second powerControlOffsetSS value for the second CSI-RS resource,
wherein one or both of the first powerControlOffset value and the first powerControlOffsetSS value is different than the second powerControlOffset value and the second powerControlOffsetSS value respectively;
transmitting the first CSI report configuration IE and the second CSI report configuration IE to a user equipment (UE);
transmitting CSI-RS using the first CSI-RS resource and the second CSI-RS resource;
receiving a CSI report with CSI measurements; and
dynamically adapting a power domain of a Physical Downlink Shared Channel (PDSCH) based on the CSI report.

2. The method of claim 1, wherein the first CSI report configuration IE and the second CSI report configuration IE have one or more of a same reportQuantity, a same reportFreqConfiguration, a same timeRestrictionForChannelMeasurements, a same timeRestrictionForInterferenceMeasurements, a same cqi-Table, and a same subbandSize.

3. The method of claim 1, wherein the CSI resource sets corresponding to the first CSI report configuration IE and the second CSI report configuration IE include equal values for some parameters.

4. The method of claim 1, wherein some of the CSI measurements are commonly reported for the first CSI report configuration IE and the second CSI report configuration IE, while remaining measurements are separately reported for each of the first CSI report configuration IE and the second CSI report configuration IE.

5. The method of claim 4, further comprising configuring which of the CSI measurements are commonly reported and which of the CSI measurements are separately reported.

6. The method of claim 4, wherein CSI-RS resource indicator (CRI), precoding matrix indicators (PMI), and rank indicator (RI) are commonly reported for the first CSI report configuration IE and the second CSI report configuration IE, and wherein channel quality information (CQI) is separately reported for the first CSI report configuration IE and the second CSI report configuration IE.

7. The method of claim 4, wherein CSI-RS resource indicator (CRI) is commonly reported for the first CSI report configuration IE and the second CSI report configuration IE, and wherein channel quality information (CQI) and rank indicator (RI) are separately reported for the first CSI report configuration IE and the second CSI report configuration IE.

8. The method of claim 4, wherein precoding matrix indicators (PMI) is commonly reported for the first CSI report configuration IE and the second CSI report configuration IE, and wherein rank indicator (RI) is separately reported for the first CSI report configuration IE and the second CSI report configuration IE.

9. A method for a user equipment (UE), the method comprising:
receiving and decoding a first Channel Status Information (CSI) report configuration information element (IE) comprising a first CSI-Reference signal (RS) resource, a first powerControlOffset value for the first CSI-RS resource, and a first powerControlOffsetSS value for the first CSI-RS resource;
receiving and decoding a second CSI report configuration IE comprising a second CSI-RS resource, wherein the second CSI report configuration IE includes a second powerControlOffset value for the second CSI-RS resource and a second powerControlOffsetSS value for the second CSI-RS resource,
wherein one or both of the first powerControlOffset value and the first powerControlOffsetSS value is different than the second powerControlOffset value and the second powerControlOffsetSS value respectively;
measuring a CSI-RS using the first CSI-RS resource and the second CSI-RS resource;
sending, to a network node, a CSI report with CSI measurements.

10. The method of claim 9, wherein the first CSI report configuration IE and the second CSI report configuration IE have one or more of a same reportQuantity, a same reportFreqConfiguration, a same timeRestrictionForChannelMeasurements, a same timeRestrictionForInterferenceMeasurements, a same cqi-Table, and a same subbandSize.

11. The method of claim 9, wherein CSI resource sets corresponding to the first CSI report configuration IE and the second CSI report configuration IE include equal values for some parameters.

12. The method of claim 9, wherein some of the CSI measurements are commonly reported for the first CSI report configuration IE and the second CSI report configuration IE, while remaining measurements are separately reported for each of the first CSI report configuration IE and the second CSI report configuration IE.

13. The method of claim 12, further comprising determining which of the CSI measurements are commonly reported and which of the CSI measurements are separately reported.

14. The method of claim 12, wherein CSI-RS resource indicator (CRI), precoding matrix indicators (PMI), and rank indicator (RI) are commonly reported for the first CSI report configuration IE and the second CSI report configuration IE, and wherein channel quality information (CQI) is separately reported for the first CSI report configuration IE and the second CSI report configuration IE.

15. The method of claim 12, wherein CSI-RS resource indicator (CRI) is commonly reported for the first CSI report configuration IE and the second CSI report configuration IE, and wherein channel quality information (CQI) and rank indicator (RI) are separately reported for the first CSI report configuration IE and the second CSI report configuration IE.

16. The method of claim 12, wherein precoding matrix indicators (PMI) is commonly reported for the first CSI report configuration IE and the second CSI report configuration IE, and wherein rank indicator (RI) is separately reported for the first CSI report configuration IE and the second CSI report configuration IE.

17. (canceled)

18. A user equipment (UE) comprising:
a processor; and
a memory storing instructions that, when executed by the processor, configure the UE to:
receive and decode a first Channel Status Information (CSI) report configuration information element (IE) comprising a first CSI-Reference signal (RS) resource, a first powerControlOffset value for the first CSI-RS resource, and a first powerControlOffsetSS value for the first CSI-RS resource;
receive and decode a second CSI report configuration IE comprising a second CSI-RS resource, wherein the second CSI report configuration IE includes a second powerControlOffset value for the second CSI-RS resource and a second powerControlOffsetSS value for the second CSI-RS resource,
wherein one or both of the first powerControlOffset value and the first powerControlOffsetSS value is different than the second powerControlOffset value and the second powerControlOffsetSS value respectively;
measure a CSI-RS using the first CSI-RS resource and the second CSI-RS resource;
send, to a network node, a CSI report with CSI measurements.

19. The UE of claim 18, wherein the first CSI report configuration IE and the second CSI report configuration IE have one or more of a same reportQuantity, a same reportFreqConfiguration, a same timeRestrictionForChannelMeasurements, a same timeRestrictionForInterferenceMeasurements, a same cqi-Table, and a same subbandSize.

20. The UE of claim 18, wherein CSI resource sets corresponding to the first CSI report configuration IE and the second CSI report configuration IE include equal values for some parameters.
